(19) United States
(12) Patent Application Publication
(10) Pub. No.: US 2001/0013481 A1
(43) Pub. Date: Aug. 16, 2001

(54) MONEY HOLDER FOR GIFT GIVING

(76) Inventor: DONNA LANG, CHATHAM, NJ (US)

Correspondence Address: MCGUIRE WOODS LLP, 1750 TYSONS BOULEVARD, SUITE 1800, MCLEAN, VA, 22102, US

(21) Appl. No.: 09/458,843

(22) Filed: Dec. 13, 1999

Related U.S. Application Data
(60) Provisional application No. 60/112,256, filed on Dec. 15, 1998.

(51) Int. Cl. B65D 85/00; B42D 3/00; B42B 5/04; A45C 1/06

(52) U.S. Cl. 206/425; 206/215; 206/459.5; 281/29; 412/36; 150/132

(57) ABSTRACT

A money holder for facilitating the giving of paper currency as a gift includes a body having two covers hingedly connected to a spine. The money holder further includes an arrangement for adhering a stack of paper currency to the body so that a currency stack may be held intermediate the two covers when the body is in a closed condition. The amount and denomination of the currency may be determined by the gift giver. When the body is in an open condition, the receiver of the gift is provided selective access to the paper currency, which may be detached from the body one bill at a time.

### BACKGROUND OF THE INVENTION

The present invention relates broadly to devices associated with presenting gifts to be given and, more particularly, to a money holder for gift giving that will retain and display a predetermined amount of paper currency.

Currency is a popular gift item, typically given for many gift giving occasions such as birthdays or graduation and is suitable for all ages. Nevertheless, one of the aspects of gift giving that enhances the enjoyment of the process for both sides is the anticipation and lack of foreknowledge on behalf of the recipient. This aspect of gift giving is often absent to a degree when gifts of currency are given.

Existing devices for giving gifts of money include a gift card or envelope having a slot or pocket designed to hold one or two bills with an opening for the presidential portrait to be visible therethrough. Many of these envelopes are sized to receive under five bills and have the rectangular dimension of the bills. Therefore, the contents of the envelope are readily discernable to the recipient expecting a gift. Further, when the gift is received, the bills are typically immediately co-mingled with other currency carried by the recipient and the gift nature of currency thusly lost.

Another method for giving gifts of currency is disclosed in Burton et al., U.S. Pat. No. 5,641,062. There, a combined greeting card and gift box apparatus is disclosed that includes a box formed from a single paper blank having a slot formed in one wall thereof with a flap covering the slotted wall. Currency is disposed on an adhesive strand, rolled within the box as seen in FIG. 2. The currency is dispensed by unrolling the adhesive strand and peeling bills therefrom. According to Burton et al. '062 an indeterminate amount of cash is dispensed from the box. Therefore, a recipient is unable to determine the exact value of the gift and the thickness of the box as well as its shape detracts from its ability to be transported easily.

There accordingly exists a need for a device for giving gifts of currency that enhances the gift giving experience, provides the recipient with the ability to determine the value of the gift while initially presenting a gift of unknown value, and provides a package that is convenient to carry and use.

### SUMMARY OF THE INVENTION

It is accordingly an option to the present invention to provide a unique device for giving gifts of money in the form of currency formed as pliant sheets that can be individually removed from the device for use.

It is another option of the present invention to provide such a device that can be assembled easily at the point of sale or by a user.

It is yet another option of the present invention to provide such a device that is readily transportable.

It is still another option to the present invention to provide such a device that may be used to provide a selectively varied amount of money as a gift.

To those ends, the present invention provides a money holder for facilitating giving paper currency as a gift that includes a body for supporting the paper currency. The body has a spine, a first cover and a second cover, the first and second covers being hingedly attached to the spine. The spine and first and second covers are each formed as generally planar members. When the money holder is in a closed condition, the body contains the paper currency intermediate the first cover and the second cover. When the money holder is in an open condition, it provides selective access to the paper currency. The money holder also includes an arrangement for adhering the paper currency to the body.

The spine and the first and second covers of a money holder according to the present invention are preferably substantially rigid.

In one preferred embodiment of the money holder according to the present invention, the arrangement for adhering the paper currency to the body includes an adhesive layer intermediate the paper currency and the spine.

In another preferred embodiment of the present invention, the arrangement for adhering includes an attachment member, a first adhesive layer for adhering the attachment member to the spine and a second adhesive layer for adhering the paper currency to the attachment member. The attachment member preferably includes a generally planar strip having an upper surface and a lower surface. The first layer of adhesive is in engagement with the lower surface and the second layer of adhesive is in engagement with the upper surface. Alternatively, the attachment member may include a pliant, generally planar strip having an upper surface and a lower surface. In this embodiment, the first layer of adhesive is preferably in engagement with at least a portion of the lower surface and the second layer of adhesive is in engagement with at least portion of the upper surface.

In yet another preferred embodiment, the arrangement for adhering includes an attachment member that includes a first generally planar strip hingedly attached to a second generally planar strip. In this embodiment, the first layer of adhesive is attached to the first generally planar strip and the second layer of adhesive is attached to the second generally planar strip.

A money holder according to the present invention preferably includes a protective layer removably attached to the second adhesive layer. This serves to prevent inadvertent adhesion of the second adhesive layer.

In another preferred embodiment of the money holder according to the present invention, the body includes at least one surface having indicia printed thereon. The indicia preferably conveys a sentiment associated with a gift giving occasion.

In an another preferred embodiment of the present invention, a money holder for facilitating giving paper currency as a gift includes a body for supporting the paper currency. The body has a spine, a first cover and a second cover. The first and second covers are hingedly attached to the spine, and the spine and first and second covers are each formed as generally planar members. When the money holder is in a closed condition, the body contains the paper currency intermediate the first cover and the second cover. When the money holder is in an open condition, selective access to the paper currency is provided. The money holder further includes an attachment member having a first adhesive layer for adhering the attachment member to the spine and a second adhesive layer for adhering the paper currency to the attachment member. The money holder according to this embodiment preferably further includes a protective layer removably attached to the second adhesive layer for preventing inadvertent adhesion of the second adhesive layer. The body of the money holder according to this embodiment preferably includes at least one surface having indicia printed thereon. The indicia preferably conveys a sentiment associated with a gift giving occasion.

The arrangement for adhering the paper currency to the spine is configured for holding a stack of paper currency of any given denomination or group of denominations. One of the features of the present invention is that the gift giver can determine the amount of money to be given with that money configured in a stack for attachment to the adhesive spine in its position intermediate the leaves. If, for example, the money holder is purchased at a bank, the gift giver can request a stack of bills of any denomination and then the bank employee or the gift giver can assemble the money holder and bill stack combination in the bank at the point of sale or the gift giver can assemble the unit later. Optionally, the gift giver can assemble their own stack of bills and assemble the money holder and bill stack combination at their leisure.

The attachment member of a money holder according to the present invention may take the form of an adhesive strip. There are several ways that this adhesive strip can be applied. Initially, it can be affixed to the spine with a peel-off cover overlying the adhesive. Secondly, a generally L-shaped adhesive strip may be provided which includes two covers and two adhesive portions with one adhesive portion being for affixation to the spine and the other adhesive portion being for receipt and affixation of the bill stack. The L-shaped strip may be formed from two hingedly connected members or formed as a single pliable member. Yet another embodiment of the present invention provides a double-sided adhesive strip which may be attached to the bills and then to the spine.

The adhesive strip may be pliant or rigid. The only requirements are that it be affixable to the spine and be sufficient to retain the bills in place for tearing off individual bills while retaining the remainder of the stack of bills within the holder.

By the above, the present invention provides a holder for currency for use in gift giving that allows the gift giver to determine the denomination and amount of currency to give, assemble the device either at the point of sale or away from the point of sale and allows the recipient to remove one bill at a time from the stack within the holder for personal use.

### BRIEF DESCRIPTION OF THE DRAWINGS

FIG. 1 is an exploded view of a money holder for gift giving according to one preferred embodiment thereof;

FIG. 2 is an exploded view of a money holder for gift giving according to a second preferred embodiment thereof;

FIG. 3 is an exploded view of a money holder for gift giving according to a third preferred embodiment thereof;

FIG. 4 is a perspective view of the money holder for gift giving during assembly;

FIG. 5 is a perspective view of the money holder for gift giving in an assembled condition;

FIG. 6 is a perspective view of the money holder for gift giving in a closed condition; and

FIG. 7 is a perspective view of the money holder for gift giving during use.

### DESCRIPTION OF THE PREFERRED EMBODIMENT

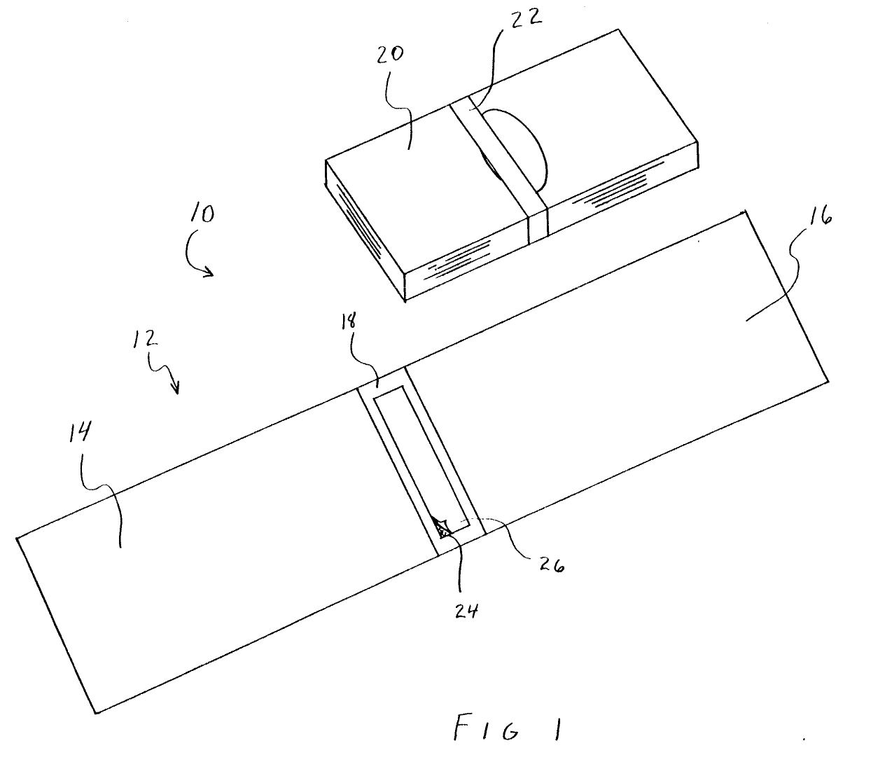

Turning now to the drawings and, more particularly to FIG. 1, a money holder for gift giving according to a first preferred embodiment of the present invention is illustrated generally at 10 and includes a body 12 formed from three individual sections including two leaves or covers 14, 16 which are generally rectangular members formed from hardboard or some other rigid material separated by a rigid spine 18 and hingedly joined thereto. When opened, the entire body 12 is a planar rectangular structure with leaves foldable into and out of opposition to one another along the hinged connection with the spine 18. FIG. 1 also illustrates a stack of bills 20 bound by conventional band 22 positioned for entry into the money holder 10.

The rectangular leaves 14, 16 are sized to be slightly larger than standard American currency. In that manner, once the stack of bills 20 is in the holder 10, the perimeter of the stack 20 is contained within the perimeter of the overlying or underlying leaf 14, 16.

According to the first preferred embodiment, an adhesive strip attachment member 24 is applied along the length of the spine 18 with the adhesive strip 24 being sized to approximate the width of the bill stack 20. A peel-off protective layer 26 is applied over the adhesive layer 24 to prevent the adhesive layer 24 from sticking to unintended surfaces. The adhesive layer 24 may be formed from glue or any adhesive sufficient to retain the bill stack 20 in a stacked, aligned condition and allow the bills to be individually peeled from the stack, as will be explained in greater detail hereinafter.

It should be understood that while it is contemplated that the money holder 10 may be filled at a bank or other location, it is within the scope and spirit of the present invention to provide a preassembled money holder with a stack of bills being applied to the adhesive during a manufacturing process.

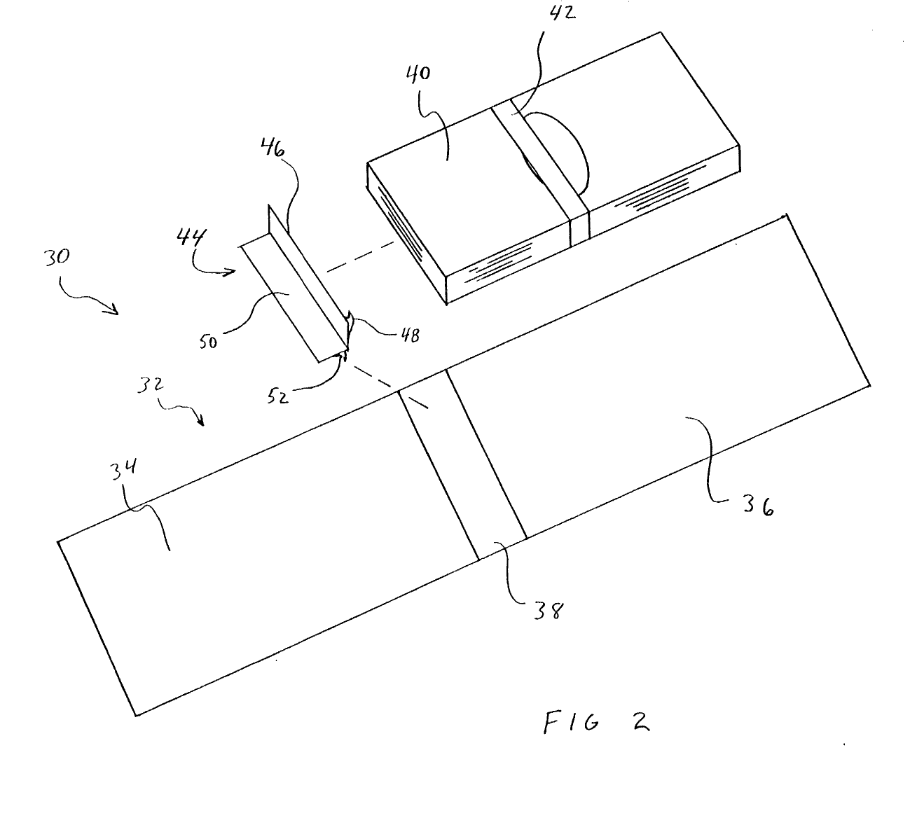

A second preferred embodiment of the present invention is illustrated in FIG. 2. There, the money holder 30 includes a body 32 having two opposing, rigid leaves or covers 34, 36 separated by a spine 38. A stack of bills 40 which, may be banded by a paper band 42, is provided for application of the money holder 30. An adhesive strand 44 is provided with the strand being similar in width to the bill stack 40 and generally L-shaped in cross section. Therefore, the adhesive strand 44 includes a first portion 46 and a second portion 50. The first portion 46 includes adhesive applied to one face thereof for mating with the bill stack 40. This layer is covered by a protective peel-off sheet or first cover portion 48. The second portion 50 is provided with the adhesive on the same side of the strand 44 as the adhesive applied to the portion 46 configured for engagement with the bill stack 40. In this manner, the first cover portion 48 may be peeled away from the adhesive portion 46 and that portion affixed to the bill stack 40. The underside of this L-shaped portion includes another peel-off cover, or second cover portion 52, which is then removed and the second portion 50 applied to the spine 38. Once assembled, this configuration allows the entire planar body 32 to open in a flattened condition without disturbing the bill stack 40.

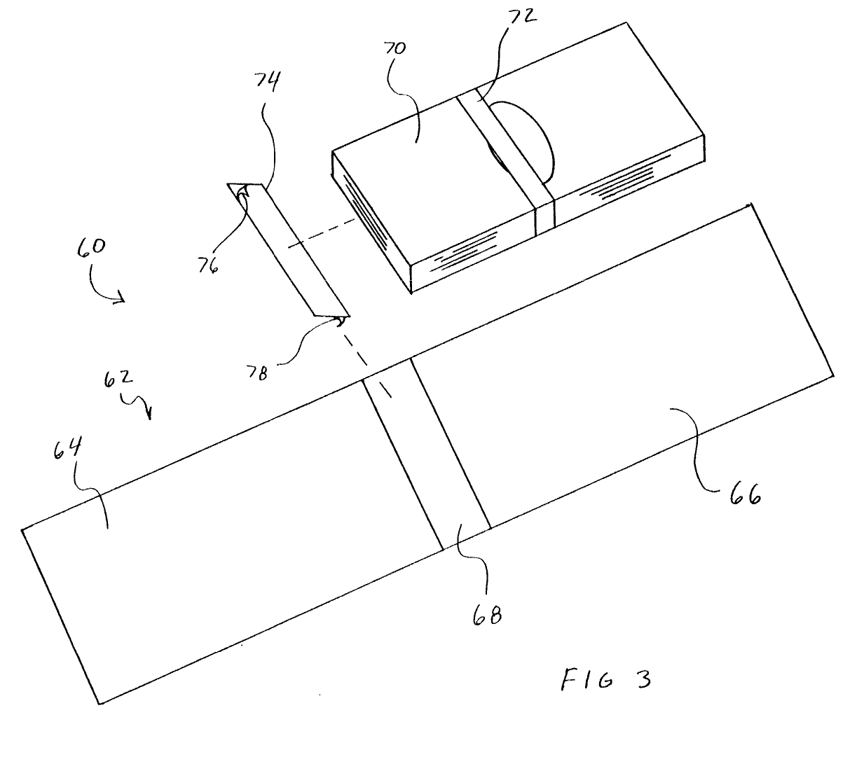

Turning now to FIG. 3, a third preferred embodiment of the present invention is illustrated, generally at 60. There, the money holder 60 includes a body 62 formed from two rigid, planar rectangular leaves or covers 64, 66 hingedly connected to a separating spine 68. The spine 68 has a width similar to the leaves 64, 66 and is likewise rigid. A bill stack 70 is provided as with the other embodiments and is banded using a paper band 72.

An adhesive strip 74 is provided as a generally flat planar member having adhesive applied to both sides with both sides having a protective peel-off cover portion 76, 78 attached thereto. According to this embodiment, one peel-off cover 76 is removed and the adhesive layer applied to the bill stack 70. The other peel-off cover 78 is then removed and the then exposed adhesive portion applied to the spine 68. It will be appreciated by those skilled in the art that the opposite is also true, i.e. the adhesive may be applied to the spine 68 prior to applying the bill stack 70.

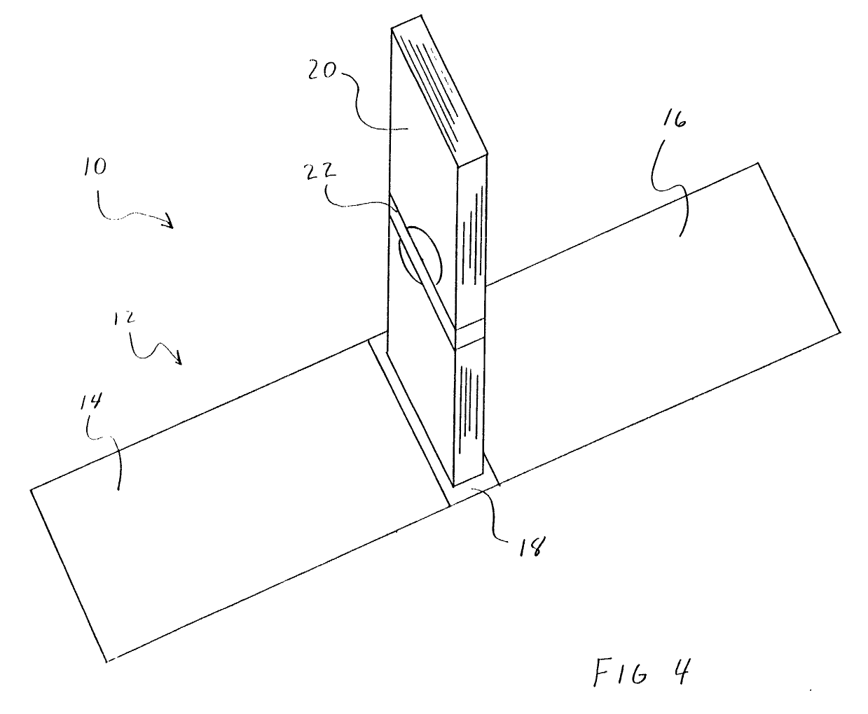

Turning now to FIG. 4, the first preferred embodiment of the money holder 10 is illustrated in an assembled condition with the leaves 14, 16 extending outwardly from upstanding bill stack 20. There, the cover layer 26 has been removed from the adhesive strip 24 as seen in FIG. 1 and the bill stack 20 applied to the exposed adhesive. It is preferable to leave the paper band 22 on the bill stack while the money holder is assembled in order to maintain alignment of the bills 20 when they are mated with the adhesive.

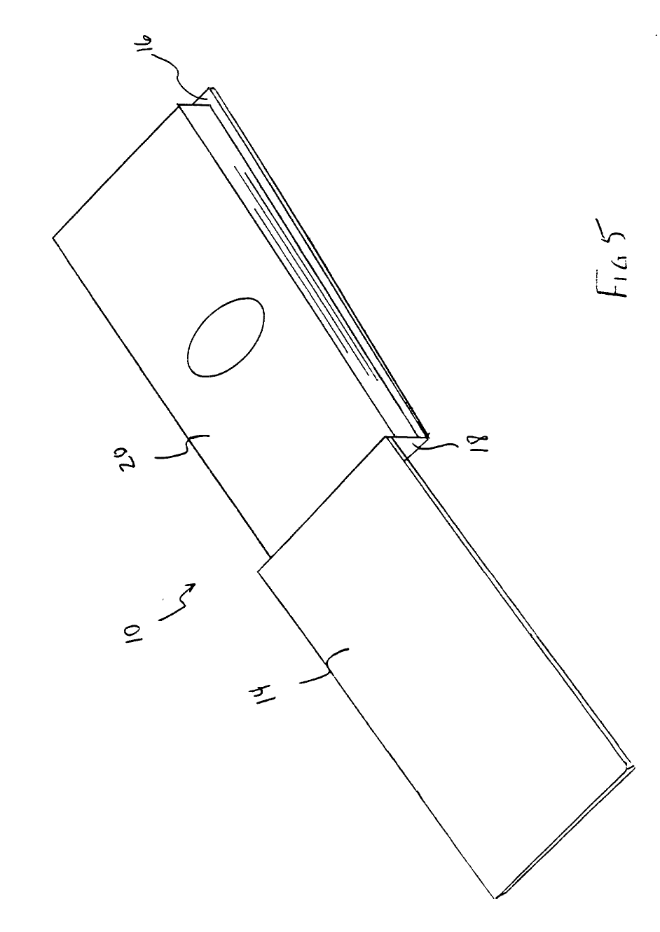

Once the adhesive has achieved a sufficient purchase of the bill stack 20, the paper band 22 may be removed and the money holder 10 of the present invention is ready for use as seen in FIG. 5.

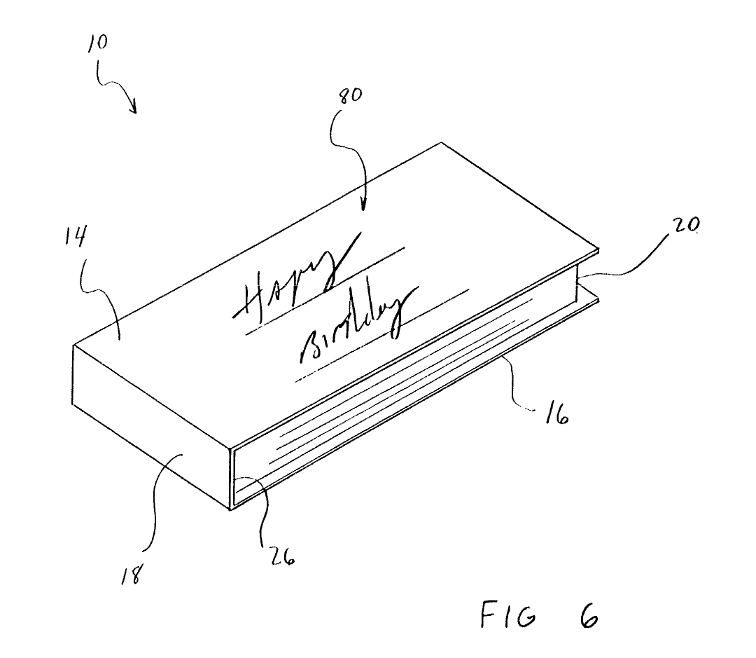

With reference to FIG. 6, it is contemplated that the money holder 10 of the present invention may be used for various gift giving occasions and each cover may depict a different theme through printed indicia 80 on one or both leaves 14, 16 or the spine 18. The indicia 80 may be varied and the outer cover may take on any appearance based on the gift giving occasion. It will also be appreciated by those skilled in the art that the outer cover may merely be decorative without specific reference to any occasion.

A portion of the fun associated with the present invention is the lack of foreknowledge on behalf of the recipient as to the quantity of bills involved. To that end, and as is supported by the on-site assembly process, the gift giver may choose any denomination and quantity of bills for arrangement in a stack to be inserted in the money holder.

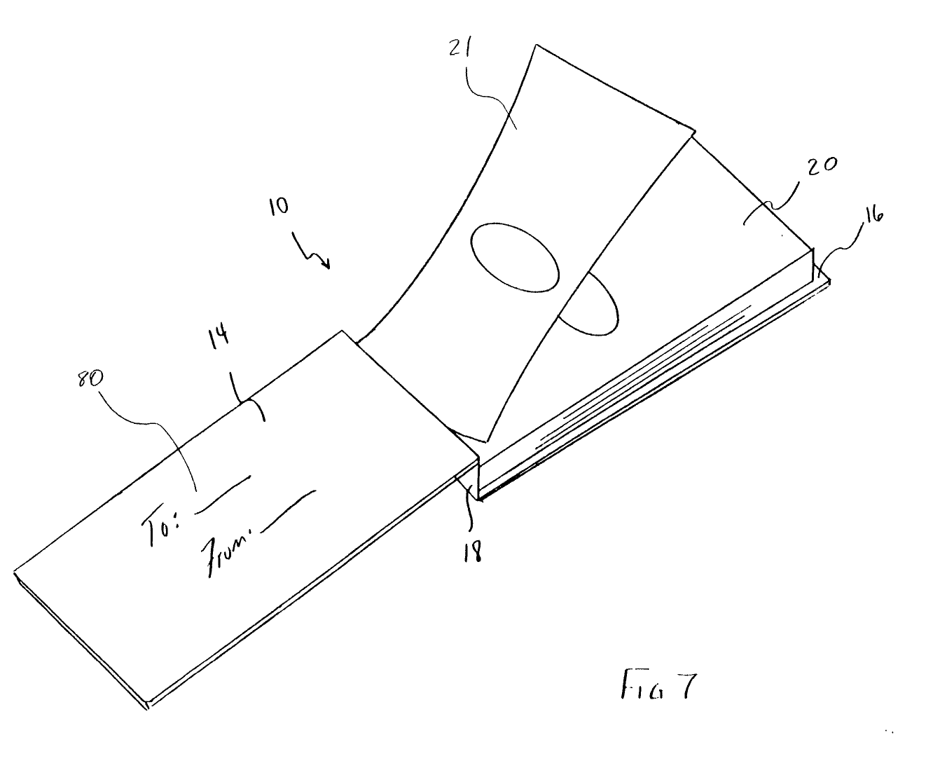

As can be seen in FIG. 7, indicia 80 may be printed on the inner surface of a cover leaf 14 and, in fact, may be printed on any exposed surface of the money holder 10. Nevertheless, no indicia or any other matter will be applied to the bills themselves. The bills remain intact except for their adherence to the adhesive strip in the money holder. The recipient of the gift may peel a single bill 21 away from the bill stack 20 for use. This reveals another bill underneath and the bills may be peeled off as required.

By the above, the present invention provides a unique and interesting device useful in giving gifts of money. The lack of foreknowledge of the recipient regarding the amount of bills contained in the money holder enhances the gift receiving experience and the gift giving experience for the gift giver.

It will therefore be readily understood by those persons skilled in the art that the present invention is susceptible of a broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements, the present invention being limited only by the claims appended hereto and the equivalents thereof.

I claim:

1. A money holder for facilitating giving paper currency as a gift comprising:
a body for supporting the paper currency and means for adhering the paper currency to said body, said body having a spine, a first cover and a second cover, said first and second covers being hingedly attached to said spine, said spine and first and second covers each being formed as generally planar members, whereby said body contains the paper currency intermediate said first cover and said second cover when said money holder is in a closed condition, and providing selective access to the paper currency when said money holder is in an open condition.

2. A money holder according to claim 1 wherein said spine and said first and second covers are substantially rigid.

3. A money holder according to claim 1 wherein said means for adhering includes an adhesive layer intermediate the paper currency and said spine.

4. A money holder according to claim 1 wherein said means for adhering includes an attachment member, a first adhesive layer for adhering said attachment member to said spine and a second adhesive layer for adhering the paper currency to said attachment member.

5. A money holder according to claim 4 wherein said attachment member includes a generally planar strip having an upper surface and a lower surface, said first layer of adhesive being in engagement with said lower surface and said second layer of adhesive being in engagement with said upper surface.

6. A money holder according to claim 4 wherein said attachment member includes a pliant, generally planar strip having an upper surface and a lower surface, said first layer of adhesive being in engagement with at least a first portion of said lower surface and said second layer of adhesive being in engagement with at least a second portion of said lower surface.

7. A money holder according to claim 4 wherein said attachment member includes a first generally planar strip hingedly attached to a second generally planar strip, said first layer of adhesive being attached to said first generally planar strip and said second layer of adhesive being attached to said second generally planar strip.

8. A money holder according to claim 4 further comprising a protective layer removably attached to said second adhesive layer for preventing inadvertent adhesion of said second adhesive layer.

9. A money holder according to claim 1 wherein said body includes at least one surface having indicia printed thereon.

10. A money holder according to claim 9 wherein said indicia conveys a sentiment associated with a gift giving occasion.

11. A money holder for facilitating giving paper currency as a gift comprising:
a body for supporting the paper currency, said body having a spine, a first cover and a second cover, said first and second covers being hingedly attached to said spine, said spine and first and second covers each being formed as generally planar members, whereby said body contains the paper currency intermediate said first cover and said second cover when said money holder is in a closed condition, and providing selective access to the paper currency when said money holder is in an open condition; and
an attachment member having a first adhesive layer for adhering said attachment member to said spine and a second adhesive layer for adhering the paper currency to said attachment member.

12. A money holder according to claim 11 further comprising a protective layer removably attached to said second adhesive layer for preventing inadvertent adhesion of said second adhesive layer.

13. A money holder according to claim 11 wherein said body includes at least one surface having indicia printed thereon.

14. A money holder according to claim 12 wherein said indicia conveys a sentiment associated with a gift giving occasion.
